(19) United States
(12) Patent Application Publication
(10) Pub. No.: US 2012/0100277 A1
(43) Pub. Date: Apr. 26, 2012

(54) JERK CURRY POWDER

(76) Inventor: Herman Derrick Lue, Miami, FL (US)

(21) Appl. No.: 13/279,916

(22) Filed: Oct. 24, 2011

Related U.S. Application Data
(60) Provisional application No. 61/455,588, filed on Oct. 22, 2010.

(51) Int. Cl. A23L 1/223

(52) U.S. Cl. 426/650

(57) ABSTRACT

A composition for a jerk curry powder includes a combination of natural ingredients including turmeric, pepper, wheat, salt, coriander, fenugreek, cumin, allspice, and cinnamon. The amounts of these ingredients may be altered to create variations of the composition, such as mild and hot variations. The jerk curry powder composition is used in the preparation of foods.

This non-provisional patent application is based on provisional patent application Ser. No. 61/455,588 filed on Oct. 22, 2010.

### BACKGROUND

Some embodiments discussed herein may relate to natural spices for use in food preparation and, more particularly to a jerk curry powder composition.

It is well known to use various spices in the preparation of various foods and particularly meats, chicken, fish, rice and stews. In particular, many cultures in the world use various spices to produce curry that enhance the flavors of cooked foods. Typically, curry is initially produced in the forum of a powder that is applied to the surfaces of meats, chicken, fish or mixed in with other ingredients prior to cooking the food. While many types of curry powder mixtures are well known throughout the world, there remains a need for a jerk curry powder that provides a unique and highly desirable flavor. The present disclosure provides a novel combination of natural spices in both a mild and hot jerk curry powder.

While certain aspects of conventional technologies have been discussed and presented to facilitate disclosure of some embodiments, Applicants in no way disclaim these technical aspects, and it is contemplated that the attached claims may encompass one or more of the conventional technical aspects discussed herein.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is it known to be relevant to an attempt to solve any problem with which this specification is concerned.

### SUMMARY

Some embodiments may address one or more of the problems and deficiencies discussed above. However, it is contemplated that some embodiments may prove useful in addressing other problems and deficiencies in a number of technical areas. Therefore the claims should not necessarily be construed as limited to addressing any of the particular problems or deficiencies discussed herein.

An advantage provided by certain embodiments is that a unique and highly desirable flavor is provided by the disclosed combination of ingredients to form a jerk curry powder. This powder may be used in the cooking of meats and other items in any conventional fashion.

These and other advantages of some embodiments are more readily apparent with reference to the detailed description.

### DETAILED DESCRIPTION OF SOME EMBODIMENTS

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and do not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” or variants thereof do NOT necessarily refer to the same embodiments. For example, language such as “some embodiments include a feature” followed by “some embodiments include an element” does NOT necessarily admit that both of the feature and the element are included in all of the same embodiments.

The attached claims and their legal equivalents can be realized in the context of embodiments other than the ones used as illustrative examples in the description herein.

The present disclosure provides for a combination of natural ingredients in a jerk curry powder composition. The jerk curry powder composition may be provided in multiple versions wherein each version has at least one different ingredient or amount of an ingredient. Some versions may include but are not limited to a mild version and a hot version.

Some embodiments may include at least one of turmeric, pepper, wheat, salt, coriander, fenugreek, cumin, allspice, and cinnamon. Some embodiments may include all of turmeric, wheat, salt, coriander, fenugreek, cumin, allspice, and cinnamon. The amount per volume of each of these ingredients may be changed according to a desired flavor or level of spice.

### EXAMPLES

Some examples of the disclosure will now be detailed. The scope of the attached claims is not limited to the examples below. All percentages (%) provided are percent-by-volume of the powder.

### Example 1

An example of a mild jerk curry powder composition of the present invention comprises the following ingredients:
30% Turmeric
15% Pepper
15% Wheat
10% Salt
10% Coriander
10% Fenugreek
5% Cumin
3% Allspice
2% Cinnamon

### Example 2

An example of a hot jerk curry powder composition of the present invention comprises the following ingredients:
25% Turmeric
20% Pepper
15% Wheat
10% Salt
10% Coriander
10% Fenugreek
5% Cumin
3% Allspice
2% Cinnamon

Throughout the detailed description herein, some embodiments have been described and detailed, wherein a variety of possible ingredients may be combined in different ways. Accordingly, any and all possible combinations of these ingredients described in accordance with these various embodiments may be desirable to manufacturers and/or may help to more successfully meet customers' specific needs and/or preferences. Consequently, any and all possible combinations of the ingredients of one embodiment or more than one embodiment or all embodiments mentioned herein are fully considered within the spirit and scope of the attached claims and their legal equivalents.

Thus, some embodiments of a jerk curry composition have been disclosed. Other embodiments are contemplated and envisioned, and therefore it is recognized that departures from the embodiments described in this disclosure may certainly exist within the spirit and scope of the attached claims and their legal equivalents. Those having an ordinary skill in the will envision other possible variations and modifications to the ingredients of the embodiments, and they will envision other possible embodiments, all of which may fall within the spirit and scope of the attached claims. The spirit and scope of the attached claims is therefore NOT limited by the descriptions and illuminations of the embodiments that have already been presented, but rather the spirit and scope can only be defined by the attached claims and their legal equivalents as interpreted under the doctrine of equivalents. Variations, alternatives, adjustments, modifications, tunings, and deviations from the embodiments of the instant disclosure are fully contemplated and envisioned within the spirit and scope of the attached claims.

What is claimed is:

1. A jerk curry powder composition comprising:
a. turmeric;
b. pepper;
c. wheat;
d. salt;
e. coriander;
f. fenugreek;
g. cumin;
h. allspice; and
i. cinnamon.

2. The jerk curry powder composition as recited in claim 1 wherein all of the listed ingredients of turmeric, pepper, wheat, salt, coriander, fenugreek, cumin, allspice, and cinnamon together constitute 100% of the volume of the composition.

3. The jerk curry powder composition as recited in claim 2 wherein at least one of the listed ingredients of turmeric, pepper, wheat, salt, coriander, fenugreek, cumin, allspice, and cinnamon is removed such that the remaining ingredients constitute 100% of the volume of the composition and wherein the flavor of the composition is not changed.

4. A mild jerk curry powder composition comprising:
a. turmeric in an amount of between 1% and 90% by volume of the composition;
b. pepper in an amount of between 1% and 75% by volume of the composition;
c. wheat in an amount of between 1% and 75% by volume of the composition;
d. salt in an amount of between 1% and 30% by volume of the composition;
e. coriander in an amount of between 1% and 30% by volume of the composition;
f. fenugreek in an amount of between 1% and 50% by volume of the composition;
g. cumin in an amount of between 1% and 50% by volume of the composition;
h. allspice in an amount of between 1% and 30% by volume of the composition; and
i. cinnamon in an amount of between 1% and 30% by volume of the composition.

5. The mild jerk curry composition as recited in claim 4 wherein:
turmeric constitutes 30% of the volume of the composition;
pepper constitutes 15% of the volume of the composition;
wheat constitutes 15% of the volume of the composition;
salt constitutes 10% of the volume of the composition;
coriander constitutes 10% of the volume of the composition;
fenugreek constitutes 10% of the volume of the composition;
cumin constitutes 5% of the volume of the composition;
allspice constitutes 3% of the volume of the composition; and
cinnamon constitutes 2% of the volume of the composition.

6. The jerk curry powder composition as recited in claim 5 wherein at least one of the listed ingredients of turmeric, pepper, wheat, salt, coriander, fenugreek, cumin, allspice, and cinnamon is removed such that the remaining ingredients constitute 100% of the volume of the composition and wherein the flavor of the composition is not changed.

7. A hot jerk curry powder composition comprising:
j. turmeric in an amount of between 1% and 80% by volume of the composition;
k. pepper in an amount of between 1% and 90% by volume of the composition;
l. wheat in an amount of between 1% and 75% by volume of the composition;
m. salt in an amount of between 1% and 30% by volume of the composition;
n. coriander in an amount of between 1% and 30% by volume of the composition;
o. fenugreek in an amount of between 1% and 50% by volume of the composition;
p. cumin in an amount of between 1% and 50% by volume of the composition;
q. allspice in an amount of between 1% and 30% by volume of the composition; and
r. cinnamon in an amount of between 1% and 30% by volume of the composition.

8. The mild jerk curry composition as recited in claim 4 wherein:
turmeric constitutes 25% of the volume of the composition;
pepper constitutes 20% of the volume of the composition;
wheat constitutes 15% of the volume of the composition;
salt constitutes 10% of the volume of the composition;
coriander constitutes 10% of the volume of the composition;
fenugreek constitutes 10% of the volume of the composition;
cumin constitutes 5% of the volume of the composition;
allspice constitutes 3% of the volume of the composition; and
cinnamon constitutes 2% of the volume of the composition.

9. The jerk curry powder composition as recited in claim 8 wherein at least one of the listed ingredients of turmeric, pepper, wheat, salt, coriander, fenugreek, cumin, allspice, and cinnamon is removed such that the remaining ingredients constitute 100% of the volume of the composition and wherein the flavor of the composition is not changed.
